(19) United States
(12) Patent Application Publication
(10) Pub. No.: US 2008/0290159 A1
(43) Pub. Date: Nov. 27, 2008

(54) System and Method for Recording Attendance in Restricted Areas, Recording Personnel Involved in an Emergency Medical Situation, and Displaying Victim's Critical Medical Information

(75) Inventors: Anthony J. Bartley, Sr., Somers, CT (US); Robert J. Stirk, JR., Naugatuck, CT (US); Mark Matheny, Hebron, CT (US); Deborah Gordon, Ellington, CT (US); Christopher Wall, New Britain, CT (US); Jeffrey Pritchard, San Diego, CA (US); Don Burdette, Manchester, CT (US); Theresa Hahn, Winchester, MA (US)

Correspondence Address: MIRICK, O'CONNELL, DEMALLIE & LOUGEE, LLP, 1700 WEST PARK DRIVE, WESTBOROUGH, MA, 01581, US

(73) Assignee: Fast Track Medical Response Systems, LLC, Somers, CT (US)

(21) Appl. No.: 12/126,229

(22) Filed: May 23, 2008

Related U.S. Application Data
(60) Provisional application No. 60/939,652, filed on May 23, 2007.

(51) Int. Cl. G06K 5/00; G08B 13/14

(52) U.S. Cl. 235/380; 340/572.1

(57) ABSTRACT

A system and method for recording personnel involved in an emergency medical situation and displaying a victim's critical medical information. There is a portable data storage device such as an RFID chip that is adapted to be worn on the person and containing personal identification and medical information of authorized personnel. There is also a portable data storage device reader such as an RFID reader that reads at least medical information from a portable data storage device. A portable display device such as a PDA displays at least the medical information read from a portable data storage device.

### CROSS REFERENCE TO RELATED APPLICATIONS

This application claims priority of Provisional Patent Application Ser. No. 60/939,652, filed on May 23, 2007, the entire disclosure of which is incorporated herein by reference.

### FIELD OF THE INVENTION

The present invention relates to the use of RFID technology to track event attendance and provide emergency medical information.

### BACKGROUND OF THE INVENTION

At sporting events and other group events, it is helpful, and sometimes critical, to know the persons in attendance, and to record and have the medical history of persons involved in or witnesses to an accident or other medical incident.

As one example of such an event, motorsports racing can be a dangerous activity for all present. The environment around a race track, particularly during the day or days of the racing event itself, is characterized by large numbers of people and powerful cars moving quickly in confined spaces. Each race track has a controlled-access area that is off-limits to the general admission attendees at the event; only members of the sanctioning body for that event are permitted within the area. At most tracks today, access to the controlled area is gained by presenting a license card and supporting personal identification.

Within the controlled-access area of a track will be the garage, where the racing team crews tune, prepare and repair the cars before and sometimes during the events. The garage area and the “pit road” of a track can be more hazardous than the race track itself. The same atmosphere of intensity, speed of execution, and high adrenalin levels exists in and around the garage area. Consequently, though most personnel are experienced and safety-conscious, accidents happen, both on the track and in the support areas for the track.

It is common practice for most of the authorized personnel to walk around within the paddock and garage areas without any means of personal identification. Most times, the member's personal ID will have been secured in the team or individual's trailer or personal car for the day.

Each of the motorsports sanctioning bodies has a set of rules and regulations that are mandatory for its members, including certain minimum safety requirements. As part of the annual license application process, for example, each applicant must submit a medical history form. Some of the sanctioning bodies require a recent medical examination report, signed by a physician, some bodies require no medical information at all. The sanctioning bodies, and sometimes the tracks themselves, typically maintain whatever records they have as paper-based documents. In some cases, they are transported from racing event to event at different tracks, in briefcases or boxes, to be made available to emergency medical personnel at each venue. At other events, the members are required to submit their medical forms at the track on the day of each event. No industry standard has been adopted for the capture, storage, and recall of critical medical and emergency contact information in the event of a medical emergency at the track.

Some of the sanctioning bodies have attempted to deal with this lack of critical information. The SCCA (Sports Car Club of America) and a some other sanctioning bodies, for example, require all drivers to have a summary personal ID and blood type on a sticker that is affixed to the driver's helmet. Even this has three glaring shortcomings: 1) it covers only the drivers, 2) it works only if the driver is wearing his/her helmet, and 3) it has limited information in an Emergency Medical Situation, and Displaying Victim's Critical Medical Information on the sticker. Most drivers, when not actually in a race car, do not wear their helmets. They are roaming around the pit area without ID and critical medical information, the same as everyone else.

### SUMMARY OF THE INVENTION

The hazardous environment and the inadequate medical emergency response documentation that exists today are addressed by the present invention. The invention brings electronic, communications, data storage and software technology to bear in a practical and easily adoptable solution to the problems.

The inventive system and method contemplates issuing to persons who are authorized to be in a particular venue, a wearable device that contains an RFID chip that includes the attendee's personal information, and potentially as well the attendee's medical information. RFID readers at the venue's entrances and exits are used to track attendees in the venue. Also, venue officials carry portable RFID readers that are coupled to PDAs. An incident involving an attendee can then be logged by an official via scanning of the attendee's RFID chip. If the incident is medical in nature, an authorized official can access the attendee's medical information by reading the RFID chip. This information can be very valuable in the treatment and care of an injured or ill attendee, both at the venue immediately following the incident, and later during transport to and care at a medical facility.

The invention enables a sanctioning body or other party conducting or overseeing an event to require that all its license holders or other authorized event attendees wear a wristband, “dog tag” necklace or other wearable device containing an RFID chip or other wirelessly-readable data storage device containing personal identification and medical information. During the annual license renewal process or at another time, such as when an attendee registers for the event, the sanctioning body or event organizer would capture this data and have it burned into a chip that is embedded in a wearable device to be worn by the member/attendee at the event. The data stored in the chip can be accessed and uploaded into a hand-held PDA by means of a portable RFID reader (either coupled to or integral with the PDA) that is carried by authorized officials such as medical emergency response personnel and/or other officials at the venue. This eliminates the need for paper forms, unattached to anything, to act as the data source for an injured but unidentified person in need of medical assistance. The data stored within each PDA can be downloaded into a computer or server at the event venue at the conclusion of the event, or the end of each day of the event. There are other valuable functions that can be performed as part of the inventive system and method.

The invention contemplates the use of a device that can be worn continuously by any authorized attendee such as a license holder while within the restricted area of the venue. The most likely device to be worn will be a plastic wristband. The wristband can come in multiple colors, glows in the dark, is designed to fit any wrist size, and has sufficient space to embed a data chip. An alternative device is a “dog tag” necklace that could be worn inside the license holder's clothing, for example as a fire suit.

Event officials, track officials and/or medical response personnel carry a hand held RFID reader that scans and reads the data chip. The data stored in the chip will appear on the PDA that the reader is either part of or to which it is attached. The response personnel then know immediately who the person is, who the emergency contact person is and their phone number, personal physician and phone number, blood type, any allergies, and other relevant personal health information. As a matter of protocol, the attending person should scan his or her own data in an Emergency Medical Situation, and Displaying Victim's Critical Medical Information chip before scanning that of the injured party. As all entries are time-stamped when uploaded, this starts the information trail that will become part of accurately recording the entire history of the incident. As everyone surrounding the accident will be wearing the personal ID, they also can be scanned in if they were involved in any way.

Another piece of hardware that can be used as part of the inventive system is a mouse pad with an embedded RFID reader that can read the data chip, and immediately transfer the data to a computer through a USB port. The most practical use of the mouse pad would be at the entrance gate to the controlled area of the event venue (e.g., a race track). This would establish secure area personnel control by determining and saving data indicative of who entered and left the area, and at what times.

At present, the identity of the person entering a venue or secure area can be verified by a membership card and personal ID. The inventive system allows security personnel to add another layer of identity, or perhaps substitute for presenting the license. The membership attendance records, and the timing of entry and departure will be of interest to the event organizers, the sanctioning body, the track owner/manager, and in certain instances to insurance companies that need to verify information for medical claims purposes. At the end of the event, or the end of each day of the event, the information in the hand-held PDAs and the information that has been collected via the mouse pad readers can be uploaded over the internet to the event overseer's main server/computer.

When the invention is used at race tracks for sanctioned events, the sanctioning body can be provided a computer to be lodged at its headquarters, through which its members/license holders will fill out their medical and personal data via the internet. From that computer, the sanctioning bodies will burn the chips for insertion into the members' wristbands. This computer can also serve as the database for storing the attendance and medical emergency event histories.

One of the many positive features of the invention is that all of the hardware is off-the-shelf equipment that is standard and relatively inexpensive. The software ties the parts of the system together.

The invention can be used in situations other than race tracks, in which it is desirable to track people as they enter and leave a certain area or location and have access to personal medical information that is carried on the person in a data storage device that is worn by the person. Examples include other commercial operations such as sporting events, music concerts and ski areas. Other applications would be any event with large groups of people.

This invention features a system for recording personnel involved in an emergency medical situation and displaying a victim's critical medical information, comprising a portable data storage device adapted to be worn on the person and containing personal identification and medical information of authorized personnel, a portable data storage device reader that reads at least medical information from a data storage device, and a portable display device that displays at least the medical information read from a storage device. The portable data storage device may comprise an RFID chip. The portable reader may comprise a hand-held, wireless RFID reader. The portable display device may comprise a PDA. The PDA and the RFID reader may be mechanically coupled, or may be integral within a single housing.

The system may further comprise a second data storage device reader located at an entrance/exit to a restricted area, that reads at least personal identification data from a portable data storage device, to track personnel located in the area. The second data storage device reader may comprise a tethered RFID reader. The system may further comprise reading data from the in an Emergency Medical Situation, and Displaying Victim's Critical Medical Information second data storage device reader and creating an attendance record of the restricted area. The system may further comprise creating a database containing the personal identification and medical information of authorized personnel.

Also featured is a system for recording attendance in a restricted area, recording personnel involved in an emergency medical situation, and displaying a victim's critical medical information, comprising a wearable article containing an RFID chip that stores personal identification and medical information of authorized personnel, a first portable, wireless RFID reader that reads at least medical information from an RFID chip, in which the data read by the first RFID reader is used to create a database containing the personal identification and medical information of authorized personnel, a PDA, mechanically coupled to or integral with the first RFID reader, that displays at least the medical information read from a storage device, and a second RFID reader located at an entrance/exit to a restricted area, that reads at least personal identification data from an RFID chip, in which data read by the second RFID reader is used to create an attendance record of the restricted area. The second RFID reader may comprise a tethered RFID reader.

The invention also features a method of recording personnel involved in an emergency medical situation and displaying a victim's critical medical information, comprising providing a portable data storage device adapted to be worn on the person and containing personal identification and medical information of authorized personnel, providing a portable data storage device reader that reads at least medical information from a data storage device, and using a portable display device to display at least the medical information read from a storage device. The portable data storage device may comprise an RFID chip. The portable reader may comprise a hand-held, wireless RFID reader. The portable display device may comprise a PDA. The PDA and the RFID reader may be either mechanically coupled together, or integral. The method may further comprise providing a second data storage device reader located at an entrance/exit to a restricted area, that reads at least personal identification data from a portable data storage device, to track personnel located in the area. The second data storage device reader may comprise a tethered RFID reader. The method may further comprise reading data from the second data storage device reader and creating an attendance record of the restricted area. The method may further comprise creating a database containing the personal identification and medical information of authorized personnel.

### BRIEF DESCRIPTION OF THE DRAWINGS

Various other objects, features and advantages of the present invention will become fully appreciated as the invention becomes better understood when considered in conjunction with the accompanying drawings showing non-limiting embodiments of the invention, in which:

FIG. 1 is a schematic diagram of an embodiment of the inventive system. This system can also be used to accomplish the inventive method; and

FIG. 2 shows an example of a data input form for member personal and medical information that is captured and stored, and written to the RFID data chip.

### DETAILED DESCRIPTION OF EMBODIMENTS OF THE INVENTION

The inventive system provides the following key features: records attendance; records persons present at an accident or other incident; and displays critical medical information about an accident victim or person requiring medical attention. The preferred embodiment of the inventive system described herein comprises six major components. One is a computer (termed the “Host”) that stores the databases, provides access to the databases through local access, through the internet (by hosting a web site), by exporting portions of the database for use on another computer in the inventive system (termed the “Remote Host”) or by exporting data for other uses. It can also import data that is e-mailed from a Remote Host. The second major component is the “Remote Host”, which can provide access to a local copy of the database in the event that internet access to the main database on the Host is not available. The third major component is a tethered RFID reader (e.g., a “MouseMat”™ from TEK Industries, Inc., Vernon, Conn.) which is electronically coupled to each Host and Remote Host by a USB cable, and can read and write to RFID tags. The fourth component is standard RFID tags, primarily located in wristbands, which will store the wearer's identification, authorizations, and medical information. The fifth component is a portable (wireless) RFID reader (e.g., a TEK Industries “Freedom”™ device), which is used to collect information at access points and incident sites, and transmits this information to a PDA via Bluetooth connection. The sixth component is a PDA. The PDA is paired with the wireless RFID reader, and stores the information read by the RFID reader (scanner). The PDA is enabled to display medical information from a tag that has been read, but only to authorized personnel. Information that is stored in the PDA can be downloaded to the Host or Remote Host via Bluetooth or the USB port, for example.

The following is a more detailed description of the specific hardware components of the preferred embodiment of the inventive system. There are one or more hand-held RFID readers, preferably a 13.56 MHz RFID reader/writer capable of reading and writing to standard 13.56 MHz RFID tags that operate with all Bluetooth compatible devices, making it easy to choose from a number of PDA devices that use Bluetooth. There are an equal number of handheld Bluetooth-compatible PDAs, running Windows Mobile 2005. These are the personal digital assistants to which the reader/writer will be paired. There are also one or more mouse pads with embedded RFID readers that act as the reader of the RFID wristbands at the entrance to the controlled-access area of the venue; this is also designed to read and write tags at 13.56 MHz. A Host PC running Windows XP or Vista, Microsoft Deluxe Office and Front Page is used by the event organizer or overseer, such as a race sanctioning body. This computer will be the web interface for authorized attendees, such as members of the sanctioning body, to load personal medical and other data onto the annual application form. This computer then feeds that data into the printer/programmer that will burn the data into the chip in the wristband. This PC will store the database of information on the attendees, such as event attendance and the detailed history of all medical emergencies or other logged incidents that occurred at events. A Smart RFID wristband printer/programmer is used to transfer the personal data from the dedicated computer onto the embedded chip in the wristband. There are a number of acceptable wristbands on the market meeting the requirements. Software components perform the following tasks: adapting PC software to a PDA application; modifying PC application to include portable RFID reader; producing the Web pages that are accessible on the PC at the sanctioning body's website; producing a custom protocol with medium security, blocking access to other RFID readers; and report generation for the tracks and for the sanctioning bodies.

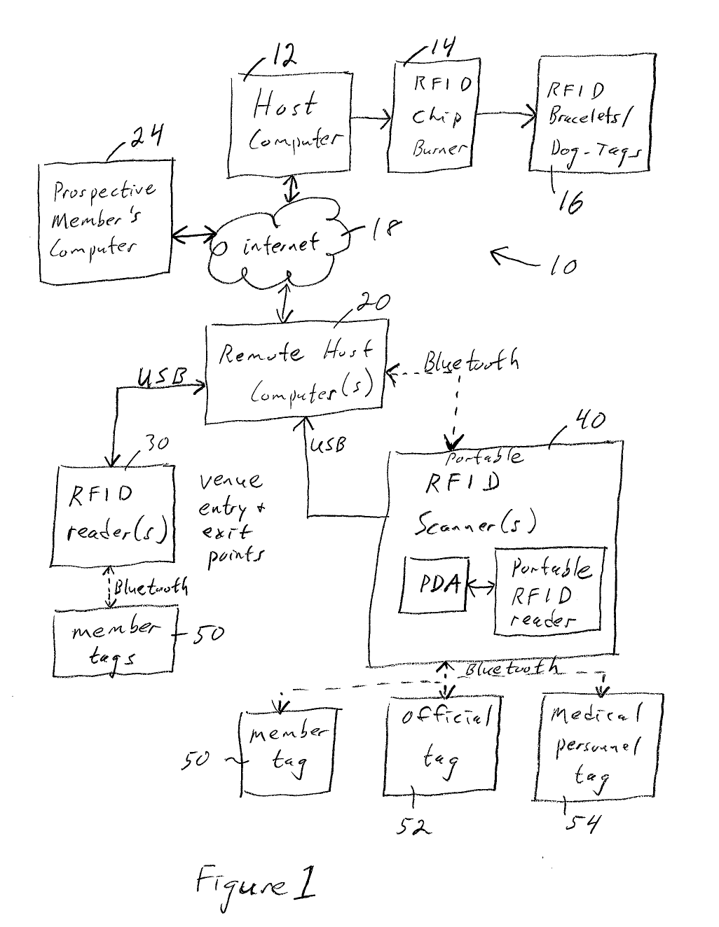

FIG. 1 schematically depicts embodiment 10 of the system of the invention, which can also be used to accomplish the method of the invention. Host computer 12 provides instructions and data to RFID chip burner 14, which then burns RFID chips 16 that are in, or are later inserted into bracelets, dog-tags, or other devices that can be worn on the person. Prospective members or existing members connect with computer 12 using their own computer 24, over the internet 18.

Remote Host computer(s) 20 connect to Host 12 over internet 18. RFID reader(s) 30, located at venue entry and exit points, wirelessly read member RFID tags 50 and provide data to Remote Host 30, typically over a hard connection, but potentially as well, wirelessly, using Bluetooth. Portable RFID Scanner(s) 40 comprise a PDA and portable RFID reader in tandem, and are used by authorized persons to scan member tags 50, official's tags 52 and medical personnel tags 54, as further explained herein.

System 10 can be provided to an event organizer or overseer, for example a race sanctioning body or race track owner, henceforth referred to as the “Owner”. The Owner will typically own all data with the exception of medical information. In many cases, a Remote Host and several reader/PDA pairs (henceforth sometimes referred to as “Scanners”) will be owned by an Owner but located at a venue, and operated by local venue personnel henceforth referred to as the “Operator”. The Operator, under authority of the Owner, will operate the system and be responsible for the accurate and timely collection and reporting of data to the Owner. In many cases, the Operator will have the right to retain and use a copy of attendance logs and incident data. Of course, other combinations of parties and rights to data are possible. As one example, the entire system can be accomplished by one party, in which case it may not be necessary to have one of the Host or Remote Host computers, as one local computer or networked system could accomplish all of the computer functionality.

The Host, Remote Host, portable RFID reader and PDA each have custom firmware installed in order to perform the necessary functions. Features and performance of the software for each of these components is specified herein. Details follow.

### I. The Host

The host is the primary repository of all data. There are four data sets (databases): Member information, Attendance logs, Incident logs, and Operator lists. These are discussed in greater detail below.

### Member Information

Members are authorized event attendees. In the embodiment, member information consists of name, address and other contact information, an identification (ID) number specified by the Owner, a list of all tags programmed, comments entered by the Owner, and member medical information. Different and/or additional information can be included as desired.

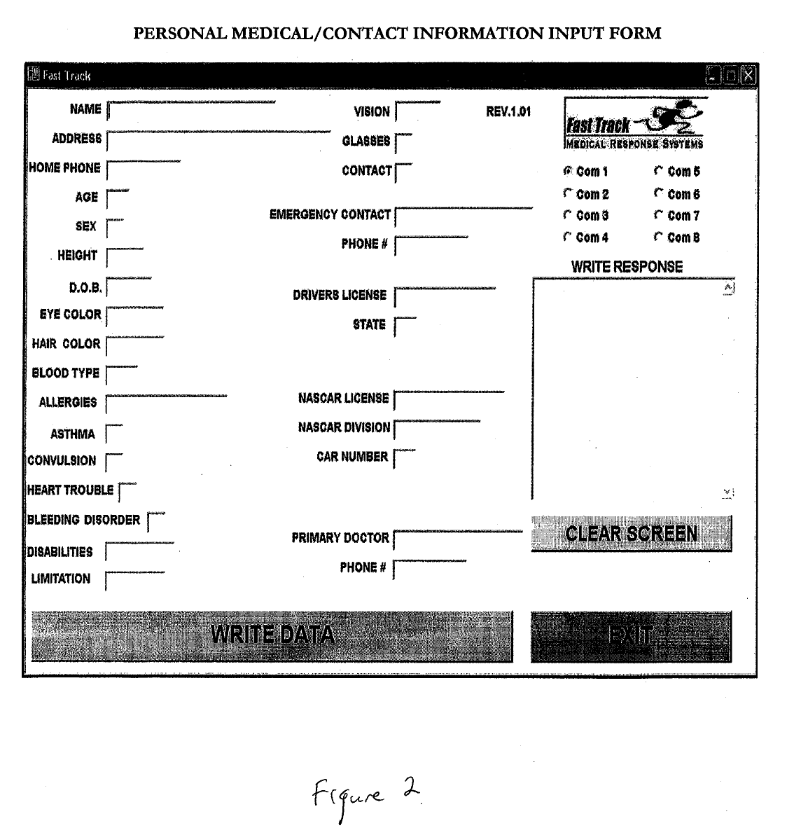

The member's medical information will be entered by the member and protected by a password which only the member knows. The member will log onto the web site hosted by the Host, enter proper ID number and password, then enter the data into a form, an example of which is shown in FIG. 2. The initial entry will use a default password provided to the member by the Owner. The member will be required to change this password the first time the member logs on to the site using the default password. The web transaction is done using SSL to protect the user's information.

Information from the Host, other than medical information, will be available to the Owner but the medical information cannot be retrieved from the database without the member's password. Information from the Remote Host, other than medical information, will be available to the Operator if so authorized by the Owner but the medical information cannot be retrieved from the database without the member's password. Once programmed into an RFID tag, the medical information can be read by a Scanner. It will remain encrypted as it is read by the reader and passed to the PDA. If the PDA is keyed by a person who was previously authorized to view medical information (such as a medic), the medical information can be displayed on the PDA screen. There is no means of exporting this medical data from the PDA. There is no other means of viewing or accessing the medical information without the member's password. In order to protect the medical information, only one RFID tag may be programmed with the member's information. The member's password is required in order to authorize programming another RFID tag.

In case the user forgets the password, a “password help” feature will be available. When logged in using the password, the member may type in a question, the answer, and then a help phrase. Later, if the user forgets the password, the user can log on using their ID and request password help. The web site will ask the question, and if the user gives the correct answer, the web site will show the help phrase. It will be recommended that the help phrase remind the user of the password, but not be the password.

### Attendance Logs

Attendance logs will preferably be gathered at entry and exit points to controlled areas, by scanning member tags using an RFID reader (which could be, for example, the MouseMat™ device, or a Scanner). Tags will be scanned as members enter, and again as they exit. Attendance logs can be downloaded to either the Host or the Remote Host, and can be e-mailed from a Remote Host to the Host. The attendance log contains only member ID numbers and a timestamp. The individual operating the entry point scanning operation will also scan his or her wristband and identify the activity (entry point, exit point, etc). This information will also be part of the log.

The Operator, if so authorized by the Owner, may export from the Remote Host a database of attendee information. This database will contain member name, address, and contact information, as well as the attendance log activity/timestamp information.

### Incident Logs

An incident log will preferably be started when an authorized official scans his/her tag and selects on the PDA “Incident” as the activity. An incident log will contain ID numbers, timestamps, and categories. A category is entered by the official after each tag is scanned, and will identify whether that tag belongs to an authorized official, a victim, a witness, or authorized medical personnel. The Operator, if so authorized by the Owner, may export a database of incident information from the Remote Host. This database will contain member name, address, and contact information, as well as timestamp information.

### Operator List

The operator list will preferably contain for each Operator, the name, contact information, authorizations, and a password used to protect database dumps sent to that Operator for use on a Remote Host. That password will reside on the Remote Host and be used to enable access to the database as authorized by the Owner.

### Owner Reports and Activities

The Owner preferably has access to the data sets in the following ways. The Owner must be local to the Host computer in order to access these functions. Access to these functions requires scanning an Owner authorized tag. Replacements for lost Owner authorized tags must typically be acquired from the system vendor.

### 1. Individual Member Data.

a. The database can be searched by name, home phone number, or ID number.

b. Once an individual record has been selected, the following fields can be edited
i. Name
ii. Status
iii. ID number
iv. Division
v. Team, Car, or Track
vi. Membership type
vii. Comments
viii. Authorization (select from list)
   1. Medic
   2. Owner
   3. Operator
   4. Official

c. The following fields can be viewed, but not edited
i. Address
ii. Home Phone
iii. Emergency contact name and phone number
iv. Physician name and phone number
v. List of tags programmed
vi. Default password (if not yet changed)

d. The member's password can be reset.
i. This will permanently delete all medical information from the database.

ii. A default password will be generated, which can be given to the member by email or other means.
iii. The member must change the password and re-enter the medical information.

e. Program tag.
i. A tag cannot be programmed until the member has logged on and changed the default password. This automatically authorizes the first tag to be programmed.
ii. A previously programmed tag belonging to the member may be reprogrammed without new authorization (normally used when user updates information and brings the original tag to a Remote Host).
iii. If a new tag must be programmed, the member must log on using his/her password, then authorize an additional tag.
iv. Each time a tag is programmed, a label is normally printed. If the appropriate label printer is available to the Host when the tag is programmed, the print dialog box will pop up. This label will be placed on the tag as a visual identifier.

f. Delete member from database.

### 2. Group Member Data.

a. Sets of data can be selected from the member database by any combination of state, membership type, division, authorizations, update required (this is a flag indicating that information has been updated in the database but not yet programmed into the tag), or license expiration date, for example.
b. Once a set of data is selected, the entire set can be dumped to a new database file for use in other applications. The exported database can contain only name and contact information, all non-medical information, or all member data. The latter is transferred to the Remote Host for its use.
c. The contact information database export and the non-medical information database export may be protected with a password. The system does not provide any means of viewing these databases.
d. The full database export is always protected by requiring that an authorized Owner or Operator RFID tag ID be scanned in order to open the database. At time of export, the particular Operator(s) and their authorization are selected. An Owner tag automatically has full authorization.
e. A selected data set may be printed in a report that contains name, address, phone number, and membership type.
f. If the selection includes ‘update required’, the data set may be exported as a change log file for loading to the Scanner. When a tag is scanned during Access In or Access Out activities (see below), the ID is compared against the change log. If a match is found, the scanner indicates that an update is required to the tag. The change log contains only a list of ID's.
g. If the selection includes license expiration date, the data set may be deleted from the database.

### 3. Attendance Data.

a. Sets of data can preferably be selected from the attendance database by any combination of venue (e.g., track), state, membership type, and date.
b. Once a set of data is selected, the set can be dumped to a new database file for use in other applications. Data exported in this manner will not contain medical information.
c. Note that since the attendance database does not contain member information other than ID, this information will be pulled from the member information database.
d. A selected data set may be printed in a report that contains name, address, phone number, and membership type, track and date.

### 4. Incident Data.

a. Sets containing one or more incident reports can preferably be selected from the incident database by any combination of venue or event, state, date and incident number (in case there is more than one incident at a given event).
b. Once a set of data is selected, the set can be dumped to a new database file for use in other applications. Data exported in this manner will not contain medical information.
c. Note that since the incident database does not contain member information other than ID, this information will be pulled from the member information database.
d. A selected data set may be printed in a report that contains the following items:
   i. Header information: Track or other venue name, date.
   ii. Official who collected the information: name, address, phone
   iii. List of witnesses: name, address, phone
   iv. List of victims: all non-medical information.
   v. List of Medics: name, address, phone.
e. The information for each incident will be listed separately, grouped by incident.
f. Comments can be added to the database, by incident, track, or under an individual associated with a particular incident.

### 5. Operator List.

a. Operators may be added or deleted, or edited.
b. Operator authorization tags may be printed. These do not contain medical information and do not require authorization by the Operator to be duplicated.

### Member Activities

All member activities are preferably accomplished through the internet at the Host web site. At the web site, the member may do the following: Log in using member ID. The ID will be assigned by the Owner, and given to the member; Change password. This is required if the password is a default (the first time a member logs in); Enter contact and medical information; Authorize a new tag to be programmed; Enter password help information; Request password help; and View Owner entered information: Sanctioning body license number, Division, team or car number

### II. The Remote Host

The Remote Host will preferably have all the capabilities of the Host, with the following exceptions. The Remote Host will not be a web server, and cannot be accessed via the internet. Also, the Remote Host requires an Operator tag for entry, instead of an Owner tag. Further, access to the member information may be authorized or restricted by the Owner. Authorizations will reside in the database file sent by the Owner. Still further, Attendance and Incident data will be limited to what is downloaded from Scanners into the Remote Host. No capability is provided for this data to be sent from the Host to the Remote Host. Finally, member information may be changed on the Remote Host, including authorization to program a new tag. If the Remote Host is internet enabled, this information will be sent immediately to the Host and stored in the member information database. If not, this information will be held in a local copy of the member information database. This will be sent to the Host at a later time for incorporation into the main member information database. Members cannot be deleted from the Host database in this manner.

### III. The Scanner

A 13.56 MHz Freedom™ RFID unit from TEK Industries is preferably used. After successfully reading a tag and transmitting the data to the PDA, it will receive a response from the PDA. This response will indicate whether that tag has been flagged in the PDA's change log (see below). The scanner must be capable of identifying the following events to the user, both audibly and visually: tag not read; tag read, no response from PDA; tag read, normal PDA response; and tag read, PDA indicates this tag is flagged.

### IV. The PDA

The software for the PDA is preferably written in VB.net which will allow it to be run on any PDA with Bluetooth capability running Windows Mobile 2005 or a compatible operating system. To run the system, the individual (henceforth referred to as the User) must perform the following steps:

1. Boot the PDA.

2. Start the application.

3. Establish the Bluetooth link (with the Freedom™ unit or PC).

4. Scan the User's tag. This enables the activity selection (see below).

5. Select an activity. The available choices are listed here and detailed below.
a. Access In.
b. Access Out.
c. Incident.
d. Medic View New (available only if user is an authorized Medic).
e. Medic View Previous (available only if user is an authorized Medic and a tag has already been scanned in Medic View New).
f. Export Data (available only if the User is an authorized Operator).
g. Import Change Log(available only if the User is an authorized Operator)

6. Select “END” to end the activity.

Data collected by the PDA for export to the Host or Remote Host is detailed elsewhere. It consists of ID's from tags scanned, and selections made on the PDA screen. The Change Log imported from the PC is detailed elsewhere. It consists of a list of ID's that are flagged as requiring update.

### Access In and Access Out

The Access In and Access Out activities preferably operate in the same fashion. Once the User selects the activity, the PDA may be placed in the charging cradle while the activity continues to run. As the activity is started, the User's ID is logged, with a timestamp. Once the activity is running, tag data is accepted from the RFID reader and checked against the Change Log(if present). A response is issued to the RFID reader indicating whether a change is required. The ID is logged with a timestamp.

### Incident

When an incident activity is started, the User's ID is preferably logged with a timestamp. Once the activity is running, each time a tag is scanned a menu will pop up asking the User to choose a category for this tag. Available categories are: Witness, Victim, Official, and Medical. The ID, category, and timestamp will be logged.

### Medic View New and Medic View Previous

The Medic View activities are preferably only available if the previously scanned Medic tag is from a person who is authorized to view medical data. When either activity is selected, a screen will pop up asking that the Medic's tag be scanned again to authorize the activity, or END. Once Medic View New is selected and authorized, medical information will be displayed from the next tag scanned.

Medic View Previous is only available if medical information has been loaded from a tag since the last time the log data was cleared. Log data is normally cleared when data is exported to Host or Remote Host. Once this activity is selected and authorized, the most recently scanned medical information is displayed. If medical information has been scanned from more than one tag, the tags may be scrolled through by selecting PREV or NEXT at the bottom of the screen. PREV will only be visible if data is available from an earlier tag scan. NEXT will only be visible if data is available from a later tag scan.

### Export Data

Two methods can preferably be used to accomplish this. In one, this activity is only available if the PDA is linked by the wired PDA port to a Host or Remote Host, and the User is an authorized Official. This will prevent any ambiguity about which PDA is being downloaded, in case multiple PDA's are in the Bluetooth range at once. Once the activity is selected, the PDA will begin transferring all the activity logs it contains to the PC. A status bar will indicate the progress of the transfer. When all data has been transferred and incorporated into the appropriate databases, a screen will pop up asking whether to delete the data from the PDA. In the other method, this activity is only available if the User is an authorized Official and an SD card or other portable data storage device is coupled to the PDA, e.g., inserted into the PDA's slot. Once the activity is selected, the PDA will begin transferring all the activity logs it contains to the SD card. A status bar will indicate the progress of the transfer. When all data has been transferred, a screen will pop up indicating the transfer is complete. Data must be cleared from the PDA using the Clear Data activity.

### Import Data

Two methods can preferably be used to accomplish this. In one, this activity is only available if the PDA is linked by the wired PDA port to a Host or Remote Host, and the User is an authorized Official. This will prevent any ambiguity about which PDA the data is being loaded to, in case multiple PDA's are in the Bluetooth range at once. Once the activity is selected, the PDA will be ready to receive a new change log from the PC. Transmission of the change log must be initiated at the PC. Any existing change log will be overwritten. A status bar will indicate the progress of the transfer. When all data has been transferred, a screen will pop up indicating that the transfer is complete. In the other method, this activity is only available if the User is an authorized Official and an SD card or other portable data storage device is coupled to the PDA, e.g., inserted into the PDA's slot. Once the activity is selected, the PDA will search the SD card's root directory for files with the ‘.clg’ extension. If any such files are found, a list is presented in a dialog box. If one is selected and “load” is clicked, that file is loaded. Any existing change log will be overwritten. A status bar will indicate the progress of the transfer. When all data has been transferred, a screen will pop up indicating that the transfer is complete.

With respect to the above description then, it is to be realized that the optimum relationships for the elements of the invention, to include variations in size, materials, shape, form, function and manner of operation, assembly and use, are deemed apparent to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will occur to those skilled in the art, it is not desired to limit the invention to the exact construction and operation shown and described, and accordingly, all suitable modifications and equivalents may be resorted to, falling within the scope of the invention.

What is claimed is:

1. A system for recording personnel involved in an emergency medical situation and displaying a victim's critical medical information, comprising:
a portable data storage device adapted to be worn on the person and containing personal identification and medical information of authorized personnel;
a portable data storage device reader that reads at least medical information from a data storage device; and
a portable display device that displays at least the medical information read from a portable data storage device.

2. The system of claim 1 in which the portable data storage device comprises an RFID chip.

3. The system of claim 2 in which the portable reader comprises a hand-held, wireless RFID reader.

4. The system of claim 3 in which the portable display device comprises a PDA.

5. The system of claim 4 in which the PDA and the RFID reader are mechanically coupled.

6. The system of claim 4 in which the PDA and the RFID reader are integral.

8. The system of claim 1 further comprising a second data storage device reader located at an entrance/exit to a restricted area, that reads at least personal identification data from a portable data storage device, to track personnel located in the area.

9. The system of claim 8 in which the second data storage device reader comprises a tethered RFID reader.

10. The system of claim 8 further comprising reading data from the second data storage device reader and creating an attendance record of the restricted area.

11. The system of claim 1 further comprising creating a database containing the personal identification and medical information of authorized personnel.

12. A system for recording attendance in a restricted area, recording personnel involved in an emergency medical situation, and displaying a victim's critical medical information, comprising:
a wearable article containing an RFID chip that stores personal identification and medical information of authorized personnel;
a first portable, wireless RFID reader that reads at least medical information from an RFID chip, in which the data read by the first RFID reader is used to create a database containing the personal identification and medical information of authorized personnel;
a PDA, mechanically coupled to or integral with the first RFID reader, that displays at least the medical information read from an RFID chip; and
a second RFID reader located at an entrance/exit to a restricted area, that reads at least personal identification data from an RFID chip, in which data read by the second RFID reader is used to create an attendance record of the restricted area.

13. The system of claim 12 in which the second RFID reader comprises a tethered RFID reader.

14. A method of recording personnel involved in an emergency medical situation and displaying a victim's critical medical information, comprising:
providing a portable data storage device adapted to be worn on the person and containing personal identification and medical information of authorized personnel;
providing a portable data storage device reader that reads at least medical information from a data storage device; and
using a portable display device to display at least the medical information read from a storage device.

15. The method of claim 14 in which the portable data storage device comprises an RFID chip.

16. The method of claim 15 in which the portable reader comprises a hand-held, wireless RFID reader.

17. The method of claim 16 in which the portable display device comprises a PDA.

18. The method of claim 17 in which the PDA and the RFID reader are mechanically coupled or integral.

19. The method of claim 14 further comprising providing a second data storage device reader located at an entrance/exit to a restricted area, that reads at least personal identification data from a portable data storage device, to track personnel located in the area.

20. The method of claim 19 in which the second data storage device reader comprises a tethered RFID reader.

21. The method of claim 19 further comprising reading data from the second data storage device reader and creating an attendance record of the restricted area.

22. The method of claim 14 further comprising creating a database containing the personal identification and medical information of authorized personnel.
